(19) United States
(12) Patent Application Publication
(10) Pub. No.: US 2012/0123143 A1
(43) Pub. Date: May 17, 2012

(54) METHOD FOR PRODUCING ALKOXY-SUBSTITUTED 1,2-BISSILYLETHANES

(75) Inventors: Alfred POPP, Unterhaching (DE); Margit STEINER-LANGLECHNER, Altoetting (DE)

(73) Assignee: WACKER CHEMIE AG, Muenchen (DE)

(21) Appl. No.: 13/294,668

(22) Filed: Nov. 11, 2011

(30) Foreign Application Priority Data
Nov. 16, 2010 (DE) 10 2010 043 996.7

(51) Int. Cl. C07F 7/18

(52) U.S. Cl. 556/435

(57) ABSTRACT

The invention relates to a method for producing alkoxy-substituted 1,2-bissilylethanes of the general formula 1

(R¹O)ₙR²₍₃₋ₙ₎Si—CH₂—CH₂—SiR²₍₃₋ₙ₎(OR¹)ₙ (1),

which comprises reacting, in a first step, a mixture containing compounds of the general formulae 2 and 3

ClₙR²₍₃₋ₙ₎Si—CH₂—CH₂—SiR²₍₃₋ₙ₎Clₙ (2)

ClₙR²₍₃₋ₙ₎Si—CH═CH—SiR²₍₃₋ₙ₎Clₙ (3)

with an alcohol of the general formula 4

R¹OH (4)

and, in a second step, subjecting the resultant mixture which contains compounds of the general formula 1 and compounds of the general formula 5

(R¹O)ₙR²₍₃₋ₙ₎Si—CH═CH—SiR²₍₃₋ₙ₎(OR¹)ₙ (5)

to reductive conditions such that the compound of the general formula 5 is converted into a compound of the general formula 1, wherein R¹ and R² are monovalent, unsubstituted or halogen-substituted hydrocarbon radicals having 1 to 16 carbon atoms and n is the value 1, 2 or 3.

### BACKGROUND OF THE INVENTION

The invention relates to the production of alkoxy-substituted 1,2-bissilylethanes from a mixture of 1,2-bischlorosilylethanes and 1,2-bischlorosilylethenes.

Alkoxy-substituted 1,2-bisorganosilylethanes are of great economic interest and now comprise a multiplicity of technical fields of application, primarily as crosslinkers for silicone sealing compounds or adhesives, or in the surface treatment of semiconductors.

In particular 1,2-bis(triethoxysilyl)ethane (CAS 16068-37-4) and 1,2-bis(trimethoxysilyl)ethane (CAS 18406-41-2) are important examples of the abovementioned product group.

The production of alkoxy-substituted 1,2-bissilylethanes has long been known and to date, two methods differing in principle are used.

Firstly, hydrosilylation, wherein not only the two-fold reaction (I) of alkoxy-H-silanes with ethyne (EP 477894, EP 189197 (comparative example 3), DE10034894 (comparative example), U.S. Pat. No. 2,637,738 (example 2) and Watanabe et al., J. Organomet. Chem., 1980, 195(3), pp. 363-374)

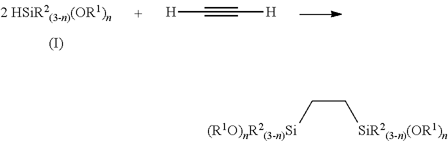

but also the reaction (II) of alkoxyvinylsilanes with alkoxy-H-silanes (Pomerantseva et al., J. Gen. Chem. USSR, 1984, 54(2), pp. 316-318) in the presence of a noble metal catalyst

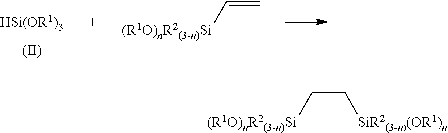

have been described.

The other variant (III) is described by Lakhtin et al. (Russian Journal of General Chemistry, 2001, 71(8), pp. 1252-1254) with the alkoxylation of the corresponding 1,2-bischlorosilylethanes

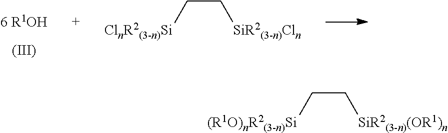

Both variants have the considerable disadvantage that the raw materials used (alkoxy-H-silanes, alkoxyvinylsilanes, 1,2-bischlorosilylethanes) need to be produced and purified independently in sometimes complex methods.

In the production (IV) of vinyl-substituted chlorosilanes (ClₙR²₍₃₋ₙ₎Si—CH═CH₂) by Pt-catalyzed hydrosilylation of ClₙR²₍₃₋ₙ₎Si—H with acetylene, by-products that are formed are, inter alia, 1,2-bischlorosilylethanes (ClₙR²₍₃₋ₙ₎Si—CH₂—CH₂—SiR²₍₃₋ₙ₎Clₙ) and 1,2-bischlorosilylethenes (ClₙR²₍₃₋ₙ₎Si—CH═CH—SiR²₍₃₋ₙ₎Clₙ).

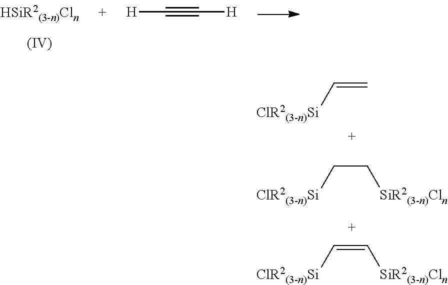

Methods for reducing these side reactions have been described, e.g. in EP 785204, but complete suppression is not possible, and so the vinyl-substituted chlorosilane must be separated off from the by-products by physical separation operations (e.g. distillation). The remaining mixture, which contains, inter alia, 1,2-bischlorosilylethanes and 1,2-bischlorosilylethenes, can be used in part as a liquid diluent in the production of vinyl-substituted chlorosilanes (DE 2131742).

The proportion of the unsaturated compound in this side reaction prevents the by-product from being able to be converted directly to the target product analogously to reaction (III). By far the majority, therefore, has not been able to be further used to date, and must be disposed of, wherein further costs of disposal arise.

### DESCRIPTION OF THE INVENTION

The invention relates to a method for producing alkoxy-substituted 1,2-bissilylethanes of the general formula 1

(R¹O)ₙR²₍₃₋ₙ₎Si—CH₂—CH₂—SiR²₍₃₋ₙ₎(OR¹)ₙ (1),

which comprises reacting, in a first step, a mixture containing compounds of the general formulae 2 and 3

ClₙR²₍₃₋ₙ₎Si—CH₂—CH₂—SiR²₍₃₋ₙ₎Clₙ (2)

ClₙR²₍₃₋ₙ₎Si—CH═CH—SiR²₍₃₋ₙ₎Clₙ (3)

with an alcohol of the general formula 4

R¹OH (4)

and, in a second step, subjecting the resultant mixture which contains compounds of the general formula 1 and compounds of the general formula 5

(R¹O)ₙR²₍₃₋ₙ₎Si—CH═CH—SiR²₍₃₋ₙ₎(OR¹)ₙ (5)

to reductive conditions such that the compound of the general formula 5 is converted into a compound of the general formula 1,
wherein
R¹ and R² are monovalent, unsubstituted or halogen-substituted hydrocarbon radicals having 1 to 16 carbon atoms and
n is the values 1, 2 or 3.

By means of the method, the waste arising in the production of vinyl-substituted chlorosilanes can be economically and ecologically converted into alkoxy-substituted 1,2-bissilylethanes of the general formula 1.

Examples of the radicals R¹ and R² are linear, branched or cyclic alkyl radicals such as methyl, ethyl, propyl, isopropyl, tert-butyl, n-pentyl, isopentyl, neopentyl, tert-pentyl, n-octyl, 2-ethylhexyl, 2,2,4-trimethyl-pentyl, n-nonyl and octadecyl radical; cycloalkyl radicals, such as cyclopentyl, cyclohexyl, cycloheptyl, norbornyl, adamantylethyl or bornyl radical; aryl or alkaryl radicals, such as phenyl, ethylphenyl, tolyl, xylyl, mesityl or naphthyl radical; aralkyl radicals, such as benzyl, 2-phenylpropyl or phenylethyl radical, and also halogenated derivatives of the abovementioned radicals, such as 3,3,3-trifluoropropyl and 3-iodopropyl radical. Preferred radicals R¹ and R² contain 1 to 10, in particular 1 to 6, carbon atoms and also optionally halogen substituents, in particular fluorine and chlorine substituents. Particularly preferred radicals R¹ and R² are methyl, ethyl, n-propyl, isopropyl, n-butyl, tert-butyl and phenyl. Particularly preferred as radicals R¹ are methyl, ethyl, n-propyl and n-butyl.

The mixture used in the first step can contain in each case only one compound of the general formulae 2 and 3, or a plurality of different compounds of the general formulae 2 and 3.

Preferably, a mixture is used here which denotes compounds in which R² is identical and is a radical from the group methyl, ethyl, propyl, n-butyl, tert-butyl and phenyl.

Preferably, a mixture is used here which contains compounds in which n has the values 2 and 3.

Particularly preferably, a mixture is used here containing 1,2-bis(trichlorosilyl)ethane and 1,2-bis-(trichlorosilyl)ethene, or a mixture containing 1,2-bis-(dichloromethylsilyl)ethane and 1,2-bis(dichloromethyl-silyl)ethene.

For the reaction in the first step with the alcohol of the general formula 4, suitably a mixture is used which the compounds of the general formulae 2 and 3 contain in a molar ratio of 1000:1 to 1:1000, particularly preferably from 100:1 to 1:100, very particularly preferably from 10:1 to 1:10.

For the reaction in the first step of the SiCl groups with the alcohol of the general formula 4 a suitable ratio of the alcohol to the available SiCl groups of the compounds of the general formulae 2 and 3 is chosen. The molar ratio alcohol:SiCl can be selected from a range from 1:1 to 1:1000, preferably from a range from 1:1 to 1:10.

The first method step can be carried out either discontinuously or else continuously, wherein a continuous process is preferred.

The first method step can be carried out with or without addition of a solvent or a solvent mixture, provided that the solvent or the solvent mixture does not affect the reaction or lead to unwanted side reactions.

If the reaction is carried out discontinuously, the reaction is preferably carried out in a suitable inert solvent or solvent mixture. If the reaction is carried out continuously, the reaction is preferably carried out without addition of a solvent or a solvent mixture.

If solvents are used in the first method step, solvents or solvent mixtures having a boiling point or boiling range of up to 120° C. at 0.1 MPa (absolute) are preferred.

The inert solvent is preferably selected from the group containing aliphatic or aromatic hydrocarbons, halogenated hydrocarbons, ethers, or mixtures of said solvents.

As solvent, the target product can also be used.

From the group of the hydrocarbons, in particular hexane, cyclohexane, petroleum ether or toluene is preferred.

The first method step can be carried out with or without addition of a catalyst. Advantageously, the reaction is carried out in the absence of a catalyst.

The hydrogen chloride formed in the first step can be separated off either chemically or physically. For the chemical separation, all methods known to those skilled in the art for binding hydrogen chloride are available. Preference is given to bases such as alcoholates of lithium, sodium and potassium with primary alcohols having 1 to 6 carbon atoms, in particular methanol, ethanol and n-butanol; such as alkali metal hydroxides and alkaline earth metal hydroxides such as LiOH, NaOH, KOH, RbOH, CsOH, Mg(OH)₂, Ca(OH)₂, Sr(OH)₂, Ba(OH₂); amides, such as sodium amide and potassium amide; hydrides, such as sodium hydride, potassium hydride and calcium hydride; primary, secondary and tertiary amines having alkyl residues having 1 to 6 carbon atoms, in particular trimethylamine and triethylamine; ammonia.

Preferably, the hydrogen chloride is reacted with a base and the reaction product is separated off. Particularly preferably, this separation proceeds using ammonia and the resultant ammonium salt is removed by filtration. The preferred physical separation proceeds via separating the hydrogen chloride by distillation.

The first method step is advantageously carried out at a temperature of −40° C. to 180° C., preferably at least 0° C., particularly preferably at least 20° C., and preferably at most 150° C., in particular at most 120° C.

For generating the reductive conditions in the second method step, all methods known to those skilled in the art come into consideration for converting the compound of the general formula 5 to a compound of the general formula 1. Preferably, the mixture is admixed in the second method step with a hydrogenation agent, in particular with hydrogen. For example, in the second method step, a catalyzed reaction with hydrogen can proceed.

As catalyst for this reaction, transition metals come into consideration, preferably elements of the iron-platinum group (groups 8-10 of the Periodic Table of the Elements) and therefrom, particularly preferably the platinum metals (Ru, Os, Rh, Ir, Pd, Pt).

The catalyst can be used in pure metallic form, as metal salt, or as metal complex. In addition, it is possible to fix it to a support material (for example activated carbon or Al₂O₃). The catalyst can then be present in the reaction mixture either homogeneously dissolved or else heterogeneously. Preferably, an immobilized catalyst is used, particularly preferably palladium on activated carbon.

The concentration of the catalyst in the reaction mixture can be varied over a wide range. Preferably, the concentration of the pure catalyst (without support material, complexing agents or the like) is at least 0.001% by weight, particularly preferably at least 0.005% by weight, and preferably at most 0.1% by weight, in particular at most 0.01% by weight.

The second method step can be carried out with or without addition of a solvent or solvent mixture, provided that the solvent or the solvent mixture does not affect the reaction or lead to unwanted side reactions.

If, in the second method step, solvents are used, preference is given to solvents or solvent mixtures having a boiling point or boiling range of up to 120° C. at 0.1 MPa (absolute).

The solvent is preferably selected from the group containing aliphatic or aromatic hydrocarbons, ethers, alcohols or mixtures of said solvents.

From the group of the alcohols, in particular alcohols of the general formula 4 are preferred. Particularly preferably, the alcohol is selected from the group consisting of methanol, ethanol and n-butanol.

If the second method step is carried out with addition of a solvent or solvent mixture, the concentration of the starting compound can have any desired value between the limits 0% and 100%. Preferably, the concentration is in a range of 20-80%, particularly preferably in a range of 50-70%.

The hydrogen required for the second method step can be provided in any desired pressure interval. Preferably, this pressure interval is between 1 and 100 bar, particularly preferably between 1 and 10 bar.

The reaction temperature required for the second method step is determined by the choice of substrate and solvent or solvent mixture. Preferably, a temperature which is between room temperature and the boiling point of the reaction mixture is chosen. More preferably, the temperature in the second method step is at least 20° C., particularly preferably at least 50° C., and preferably at most 120° C., in particular at most 100° C.

The reaction progress may be determined readily using conventional methods such as, for example, gas chromatographically or by HPLC. The reaction time is selected in such a manner that the desired proportion of the unsaturated compound of the general formula 5 has reacted to completion.

Between the two method steps according to the invention, there can be interposed a purification step. Preferably, the product after the first method step is subjected to a purification by distillation before the procedure continues with the second method step.

By means of the method according to the invention, preferably the alkoxy-substituted 1,2-bissilylethanes can be produced, in particular 1,2-bis(trialkoxy-silyl)ethanes, 1,2-bis(dialkoxymethylsilyl)ethanes and 1,2-bis(monoalkoxydimethylsilyl)ethanes, wherein alkoxy is preferably methoxy or ethoxy.

Thus, using the method according to the invention, preferably a mixture containing 1,2-bis(trichloro-silyl)ethane (Cl₃Si—CH₂—CH₂—SiCl₃) and 1,2-bis(trichloro-silyl)ethene (Cl₃Si—CH═CH—SiCl₃) is reacted with an alcohol of the general formula 4, ethanol, and the resultant reaction mixture is subjected to a reduction with hydrogen in the presence of palladium, such that the target product 1,2-bis(triethoxysilyl)ethane ((EtO)₃Si—CH₂—CH₂—Si(OEt)₃) is obtained.

In a preferred embodiment, the method according to the invention is carried out as follows:

Preferably, a mixture containing compounds of the general formulae 2 and 3 is charged into a reaction vessel and preferably dissolved in an inert solvent, for example toluene.

Then, the alcohol of the general formula 4, e.g. ethanol, is added to the solution and the contents of the reaction vessel mixed well. Preferably, there follows the addition of ammonia, preferably until the added ammonia is no longer bound by hydrogen chloride. Ammonium chloride precipitated out is preferably removed by filtration and the filtrate is preferably purified by distillation. The first method step can equally proceed by continuous reaction of the mixture of the compounds of the general formulae 2 and 3 with the alcohol of the general formula 4 in a reaction column, for example in the counterflow method. In this case, hydrogen chloride formed is preferably removed from the reaction system by distillation.

The second method step can be carried out either continuously or discontinuously, for example by hydrogenation of the mixture obtained in the first step in a solvent such as alcohol, e.g. ethanol, preferably in an autoclave. For this purpose a palladium catalyst is preferably added to the solution and the reaction is preferably carried out at elevated hydrogen pressure.

Thus, by means of the method according to the invention, advantageously, since it is simple and economic, for example 1,2-bis(triethoxysilyl)ethane can be produced with an outstanding yield starting from a mixture of 1,2-bis(trichlorosilyl)ethane and 1,2-bis(trichlorosilyl)ethene.

All of the abovementioned symbols of the above-mentioned formulae have their meanings in each case independently of one another. In all of the formulae the silicon atom is quadrivalent.

In the following examples, unless otherwise stated, all amounts and percentages are based on the weight, all pressures are 0.10 MPa (absolute) and all temperatures 20° C.

### Example 1

### According to the Invention

Into a 2 l flask with thermometer, reflux cooler, stirrer and a feed vessel, under nitrogen blanketing, 300 g of a mixture containing 1,2-bis(trichlorosilyl)ethane (79%), bis(trichlorosilyl)ethene (12%), trichlorovinylsilane (6%) and trichloroethylsilane (3%) in 200 ml of toluene as solvent are charged and brought to and maintained at a temperature of 50-60° C. Then, 300 g of ethanol at this temperature are added and the mixture is further stirred for 60 min at this temperature. Then, in the course of 60 min, a majority of the resultant hydrogen chloride is expelled by introducing nitrogen. Remaining hydrogen chloride is bound by introducing gaseous ammonia. After ammonia uptake has been completed, the mixture is further stirred for 10 min at 50-60° C. in order to complete the reaction. The salt paste is filtered off and the filtrate is purified by distillation (40 cm column packed with glass packing elements, automatic column head with reflux ratio 10:1, p=1 mbar, bottom phase temperature up to 166° C., boiling point of the product mixture 128-130° C.) 40 g of the distillate are dissolved in 20 g of ethanol and 0.02 g of catalyst (5-10% palladium on activated carbon powder, E1525 MA/W 10% from Degussa) is added. The suspension is pressurized with 5 bar hydrogen in an autoclave and heated to 80° C. After 4 h the reaction is ended, the catalyst is filtered off and the product is purified by distillation. The product 1,2-bis(triethoxysilyl)ethane is obtained having a purity of 97.5% (n_{D}²⁰=1.4090, HCl content=2.3 ppm, Hazen color index=46). Palladium is no longer detectable in the product. The composition is evaluated in each case by gas chromatography.

### Example 2

### According to the Invention

Experimental procedure and analytical results comparable with example 1, but for separating off the hydrogen chloride sodium ethylate is used and the resultant NaCl is filtered off.

### Example 3

### According to the Invention

Experimental procedure and analytical results comparable with example 1, but as inert solvent, instead of toluene, petroleum ether is used.

### Example 4

### According to the Invention

Experimental procedure and analytical results comparable with example 1, but as inert solvent, instead of toluene, the product 1,2-bis(triethoxysilyl)ethane is used.

### Example 5

### According to the Invention

Experimental procedure and analytical results comparable with example 1, but as palladium catalyst, palladium/activated carbon (10% Pd) from Merck is used at a hydrogen pressure of 1 bar. The reaction was ended after 6 hours.

### Example 6

### According to the Invention

Experimental procedure and analytical results comparable with example 1, but in the hydrogenation 164 g containing 1,2-bis(triethoxysilyl)ethane and 1,2-bis(triethoxysilyl)ethene are dissolved in 154 g of ethanol and brought to reaction with 5 g of 10% Pd/C 50% H₂O type K-02105 from Heraeus at a hydrogen pressure of 1 bar. The reaction was ended after 1 hour.

What is claimed is:

1. A method for producing alkoxy-substituted 1,2-bissilylethanes of the general formula 1
(R¹O)ₙR²₍₃₋ₙ₎Si—CH₂—CH₂—SiR²₍₃₋ₙ₎(OR¹)ₙ (1),
which comprises reacting, in a first step, a mixture containing compounds of the general formulae 2 and 3
ClₙR²₍₃₋ₙ₎Si—CH₂—CH₂—SiR²₍₃₋ₙ₎Clₙ (2)
ClₙR²₍₃₋ₙ₎Si—CH═CH—SiR²₍₃₋ₙ₎Clₙ (3)
with an alcohol of the general formula 4
R¹OH (4)
and, in a second step, subjecting a resultant mixture from the first step, which contains compounds of the general formula 1 and compounds of the general formula 5
(R¹O)ₙR²₍₃₋ₙ₎Si—CH═CH—SiR²₍₃₋ₙ₎(OR¹)ₙ (5)
to reductive conditions such that the compound of the general formula 5 is converted into a compound of the general formula 1,
wherein
R¹ and R² are monovalent, unsubstituted or halogen-substituted hydrocarbon radicals having 1 to 16 carbon atoms and
n is 1, 2 or 3.

2. The method as claimed in claim 1, wherein the radicals R¹ are selected from the group consisting of methyl, ethyl, n-propyl and n-butyl.

3. The method as claimed in claim 1, wherein the radicals R² are identical and are radicals selected from the group consisting of methyl, ethyl, propyl, n-butyl, tert-butyl and phenyl.

4. The method as claimed in claim 1, wherein the mixture used in the first step contains the compounds of the general formulae 2 and 3 in a molar ratio of 100:1 to 1:100.

5. The method as claimed in claim 1, wherein, in the first step, the reaction with the alcohol of the general formula 4 proceeds continuously.

6. The method as claimed in claim 1, wherein the reductive conditions in the second method step comprise a catalyzed reaction with hydrogen.

7. The method as claimed in claim 2, wherein the radicals R² are identical and are radicals selected from the group consisting of methyl, ethyl, propyl, n-butyl, tert-butyl and phenyl.

8. The method as claimed in claim 3, wherein the mixture used in the first step contains the compounds of the general formulae 2 and 3 in a molar ratio of 100:1 to 1:100.

9. The method as claimed in claim 7, wherein the mixture used in the first step contains the compounds of the general formulae 2 and 3 in a molar ratio of 100:1 to 1:100.

10. The method as claimed in claim 4, wherein, in the first step, the reaction with the alcohol of the general formula 4 proceeds continuously.

11. The method as claimed in claim 9, wherein, in the first step, the reaction with the alcohol of the general formula 4 proceeds continuously.

12. The method as claimed in claim 5, wherein the reductive conditions in the second method step comprise a catalyzed reaction with hydrogen.

13. The method as claimed in claim 11, wherein the reductive conditions in the second method step comprise a catalyzed reaction with hydrogen.
